(19) United States
(12) Patent Application Publication
(10) Pub. No.: US 2008/0310514 A1
(43) Pub. Date: Dec. 18, 2008

(54) Adaptive Density Search of Motion Estimation for Realtime Video Compression

(75) Inventors: Akira Osamoto, Inashiki (JP); Osamu Koshiba, Tsukuba (JP)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED

(21) Appl. No.: 12/140,139

(22) Filed: Jun. 16, 2008

Related U.S. Application Data
(60) Provisional application No. 60/943,875, filed on Jun. 14, 2007.

(51) Int. Cl. H04N 7/26

(52) U.S. Cl. 375/240.16; 375/E07.123

(57) ABSTRACT

A motion estimation (ME) apparatus and method for approximating motion in a macroblock of an image. The ME method includes selecting at least one search center in the macroblock; searching for an adaptive density lattice, wherein the adaptive density lattice search results in a motion vector for the at least one selected search center; performing skip box search to refine the resulting motion vector; selecting a partition size for the macroblock utilizing the refined motion vector, resulting in a motion vector candidate; and performing a sub-pel refinement for the motion vector candidates.

### CROSS-REFERENCE TO RELATED APPLICATIONS

This application claims benefit of U.S. provisional patent application Ser. No. 60/943,875, filed Jun. 14, 2007, which is herein incorporated by reference.

### BACKGROUND OF THE INVENTION

1. Field of the Invention

Embodiments of the present invention generally relate to a method and apparatus for motion estimation.

2. Description of the Related Art

In certain standards, motion estimation is among the most influential parts on encoding performance of image and video compression. The performance of motion estimation and complexity (or required time) for its processing form have an inverse relationship.

In image and video compression, a certain fast motion estimation algorithm is used in order to provide a better performance. However, such algorithms may be very time consuming. A three step search is usually used to reduce a reasonable amount of complexity and to accommodate the hardware implementation. Though such a search performance is generally acceptable, it performs poorly when dealing with several source sequences. Such sequences include a sequence with uniform motion and high detailed texture. The degradation is usually caused by the inappropriate assumption of the algorithms that the error surface of search space is smooth.

Therefore, there is a need for a method and apparatus for an improved mechanism of motion estimation in an image or video.

### SUMMARY OF THE INVENTION

Embodiments of the present invention relate to a motion estimation (ME) apparatus and method for approximating motion in a macroblock of an image. The ME method includes selecting at least one search center in the macroblock; searching for an adaptive density lattice, wherein the adaptive density lattice search results in a motion vector for the at least one selected search center; performing skip box search to refine the resulting motion vector; selecting a partition size for the macroblock utilizing the refined motion vector, resulting in a motion vector candidate; and performing a sub-pel refinement for the motion vector candidates.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an exemplary embodiment of a block diagram depicting a P-picture macroblock in accordance with the present disclosure;

FIG. 2 is an exemplary embodiment of a block diagram depicting a B-picture macroblock in accordance with the present disclosure;

FIG. 3 is an exemplary embodiment of a diagram depicting a neighboring motion vectors;

FIG. 4 is an exemplary embodiment of an adaptive density lattice;

FIG. 5 is a diagram depicting an exemplary embodiment of a scatter level of neighboring motion vectors;

FIG. 6 is a diagram depicting an exemplary embodiment of a skip box search;

FIG. 7 is an exemplary embodiment of a diagram depicting selecting the best partition size for P-picture macroblock or H.264 B-picture macroblock;

FIG. 8 is an exemplary embodiment of a diagram depicting unifying search results for P-picture macroblock or H.264 B-picture Macroblock;

FIG. 9 is a flow diagram depicting an exemplary embodiment of direct motion compensation;

FIG. 10 is a diagram depicting an exemplary embodiment of a format of core experiment results; and

FIG. 11 is a diagram depicting an exemplary embodiment of search areas for “wide” option.

### DETAILED DESCRIPTION

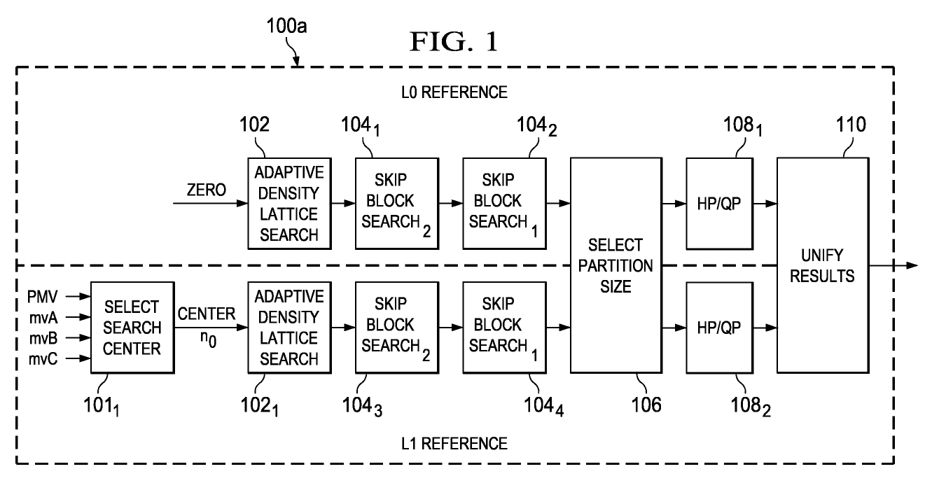

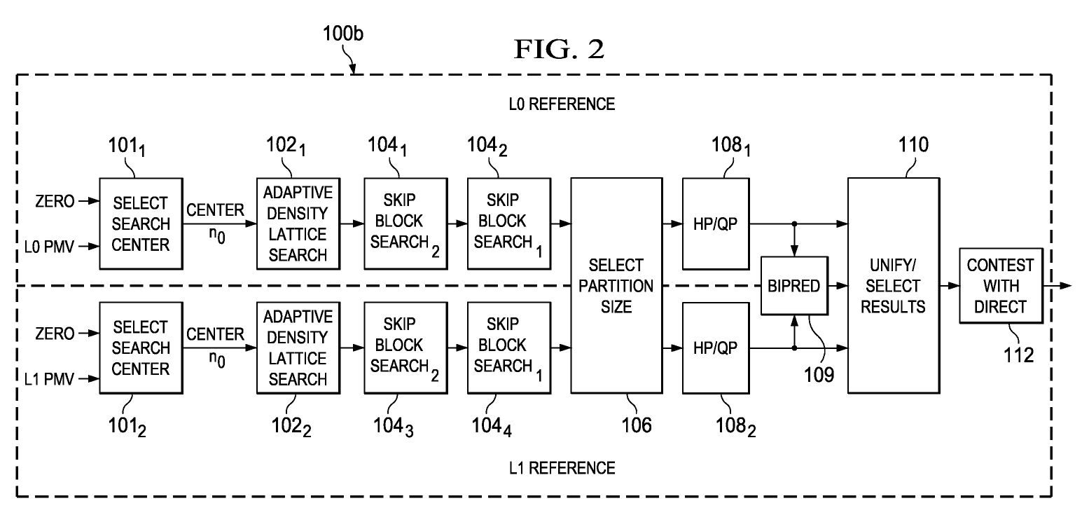

FIG. 1 is an exemplary embodiment of a block diagram 100 depicting a P-picture macroblock in accordance with the present disclosure. FIG. 2 is an exemplary embodiment of a block diagram 100_{b} depicting a B-picture macroblock in accordance with the present disclosure.

The select search center 101₁₋₂ selects a number, such as, two, of center positions of the search. A P-picture macroblock uses the zero vector (=(0,0)) in addition to a position that is determined by using neighboring motion vectors. A B-picture macroblock selects one center position for each direction (L0 and L1). Adaptive density lattice search (ADLS) 102₁₋₂ then searches for the best motion vector of, for example, 16×16, 16×8, 8×16 and 8×8 partition for each selected center position at, for example, four, two or one-pel precision. In case of the precision of ADLS 102₁₋₂ is not equal to one-pel, skip box search (SBS) 104₁₋₄ is performed to refine motion vectors to one-pel precision, tracking to the appropriate/best motion vector. Using the full-pel precision motion vectors and evaluated costs, the select partition size 106 selects a partition size for the macrobloc.

The HP/QP 108₁₋₂ performs sub-pel refinement for the motion vector candidates for each partition. For a B-picture macroblock, Bipred 109 evaluate bi-directional prediction using the sub-pel refined motion vectors. Subsequently, the unify results 110 unifies a number, such as, two (in case of P-picture macroblock) or three (in case of B-picture macroblock), of candidates into one motion compensation mode. In case of a B-picture macroblock, the contest with direct 112 compares the unified motion compensation mode and direct mode to get the final result.

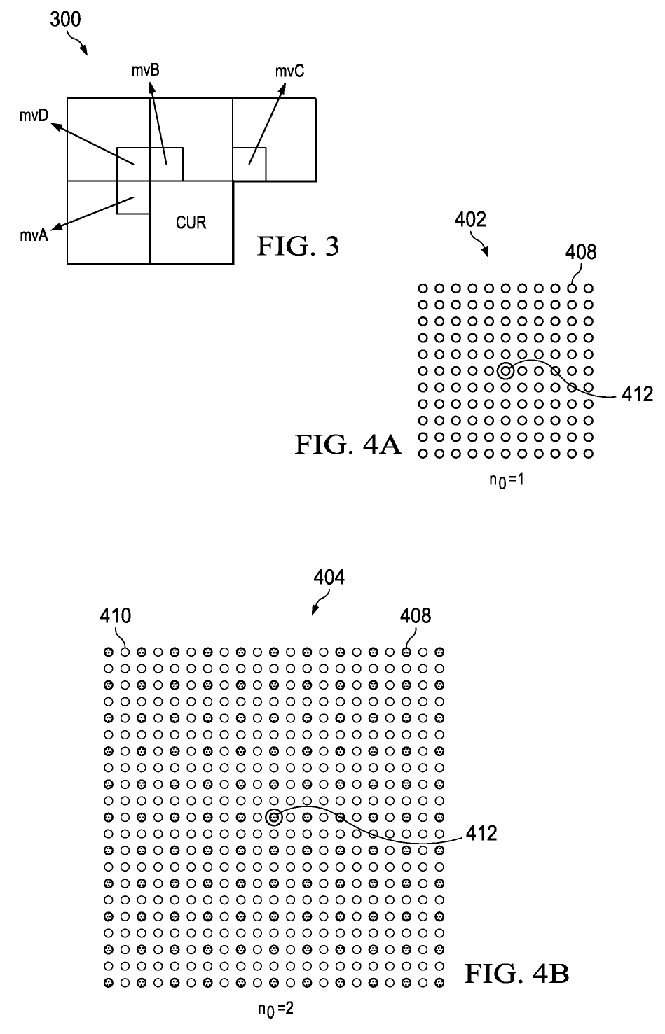

FIG. 3 is an exemplary embodiment of a diagram depicting a neighboring motion vectors. For a P-picture macroblock, the zero motion vector (=(0,0)) is used as one of center positions of its search. Another position is selected out of the followings: Round(pmv), Round(mvA), Round(mvB), Round(mvC). If mvC is not available, use Round(mvD) instead Round(v) denotes the operation that converts a quarter-pel precision vector v into its nearest integer-pel position. For example, pmv is a H.264 motion vector predictor for 16×16 partition of the current macroblock and mvA, mvB, mvC and mvD is motion vector of left, above, above-right and above-left neighboring block, respectively. The position that provides the minimum SAD with luminance samples of the current macroblock is selected.

For a B-picture macroblock, usually a smaller SAD results in a better position, such as, Zero motion vector=(0,0) and Round(pmv). In some embodiment, the number of evaluation points is kept constant for P- and B-picture macroblocks. Usually, a P-picture macroblock uses four candidates, while a B-picture macroblock evaluates two candidates for each search direction, resulting in four candidates in total.

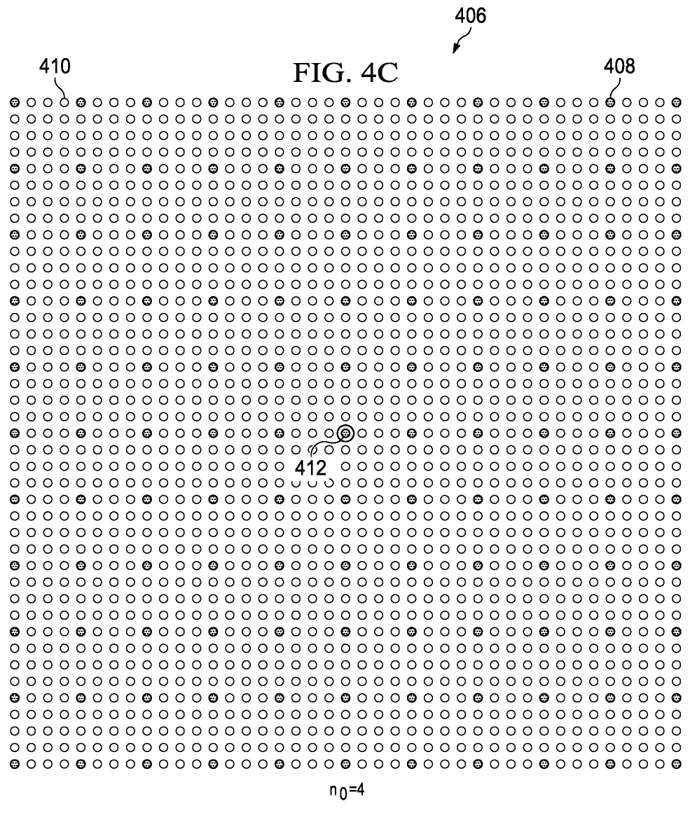

FIG. 4 is an exemplary embodiment of an adaptive density lattice. Adaptive density lattice search (ADLS) is an algorithm for the first step full-pel search. Usually, it includes a wide area with sparse search or a narrow area with dense search, keeping the number of search points constant. FIG. 4 shows three kinds of search pattern: search pattern 402 with spacing of one, search pattern 404 with spacing of two and search pattern 406 with spacing of four. Each dot represents an integer-pel position. Black points 408 are search points, while light gray points 410 are skipped positions. Black double circles 412 represent the centers of search. If the center position is highly reliable, a wide search area is not needed and the search pattern 402 is used to get high quality motion vectors without the risk of trapped by local minima. As shown in the search pattern 406, if the center position is not very reliable, a wider search area is searched at expense of losing search quality by skipping several positions. The search pattern 404 may be used for intermediate cases. In such an algorithm, search points of ADLS may be expressed as follows: S={(n₀x−cₓ, n₀y−c_{y})|x,y=−5,−4, . . . , +4,+5}, where (cₓ, c_{y}) is the center of search, n₀ denotes the density of search, which is 1, 2 or 4.

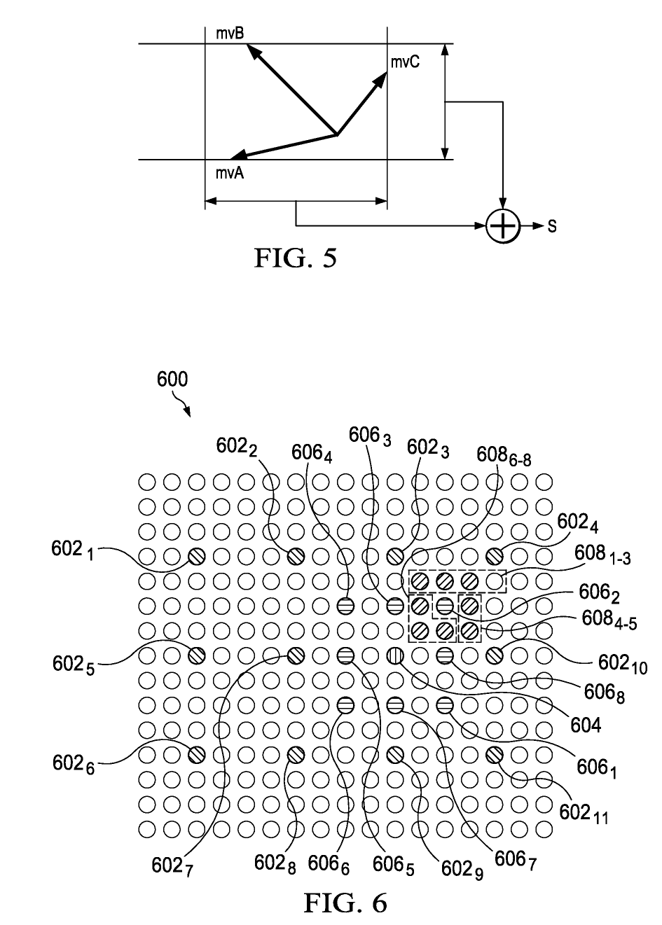

FIG. 5 is a diagram depicting an exemplary embodiment of scatter level of neighboring motion vectors. We assume that a search center is reliable if the scatter level of the surrounding motion vector is low enough. Therefore the density of search, n₀, is determined from the scatter level as follows:

$${n}_{0} = \{ \begin{matrix}1 & ( s < {s}_{1} ) \\ 2 & ( {s}_{1} \leq s < {s}_{2} ) \\ 4 & ( {s}_{2} \leq s )\end{matrix}$$

where, s₁ and s₂ are predetermined threshold values and set to 40 and 80, respectively, in this report.

For each search point, a luminance SAD and a motion vector penalty of each partition in 16×16, 16×8, 8×16 and 8×8 partition size are evaluated to get the best motion vector (the minimum cost) for each partition.

Full-pel skip box search is optionally performed to refine motion vectors to one integer-pel precision, and whether it is performed or not depends on the density of the preceding ADLS search as shown in Table 1.

TABLE 1
SBS Search Application

| Density | SBS₂ | SBS₁ |
|---|---|---|
| 1 | | |
| 2 | | X |
| 4 | X | X |

To suppress increase of computation complexity, we can track only one search position when we perform SBS₂ and SBS₁. The best 16×16 motion vector is used as a tracking vector in our algorithm. Therefore, SBS₂ searches around the best 16×16 motion vector that is obtained by the preceding ADLS search (when its density equals to four). SBS₁ searches around the best 16×16 motion vector that is obtained by the ADLS search (when its density equals to two) or SBS₂. The search points are:

SBS₂:(cₓ^{SBS}^{₂}+2u,c_{y}^{SBS}^{₂}+2v)

SBS₁:(cₓ^{SBS}+u,c_{y}^{SBS}+v)

−1≦u,v≦+1 excluding u=v=0

where, c^{SBSn} denotes the center position for SBSₙ, that is, the best 16×16 motion vector obtained by the preceding search.

FIG. 6 is an exemplary embodiment of a diagram 600 depicting a skip box search. Points 602₁₋₁₁ show (a part of) ADLS with density of four and a Point 604 is the best 16×16 search position of the ADLS. SBS₂ may search a number of locations, such as, eight locations 606₁₋₈, surrounding the point 604. If the top right corner provides the minimum cost for 16×16 partition, then SBS₁ searches eight points 6081₁₋₈ around the position.

For each search point, SAD and motion vector penalty for each partition of partition size, such as, 16×16, 16×8, 8×16 and 8×8, are evaluated to get the best motion vector (the minimum cost), similar to the ADLS. The motion vectors for any partitions may keep the best ADLS vectors unchanged if SBS₂ and SBS₁ (if applicable) do not provide better motion vectors for the partitions.

After full-pel search, the partition size for the current macroblock is determined, such candidates may 16×16, 16×8, 8×16 and 8×8 partitions. A luminance SAD and a motion vector penalty are considered for each partition upon the selection. For example, for a partition size of 8×8, an additional partition penalty is added to reflect the syntax overhead of the 8×8 partition size.

In case of H.264, long code-word for mb_type and additional sub_mb_type syntax elements for four macroblock partitions are considered to be overhead. In the proposed algorithm, penalty that is corresponding to 9-bit and 13-bit are added to P- and B-picture 8×8 partition size, respectively. Other compression standards that allow 8×8 partition, such as, MPEG-4 and VC1, may need other penalty terms of that reflect the syntax definitions. H.264 B-picture macroblocks may use mixed-directional motion compensation; hence, they may be processed in the same fashion as the P-picture macroblocks.

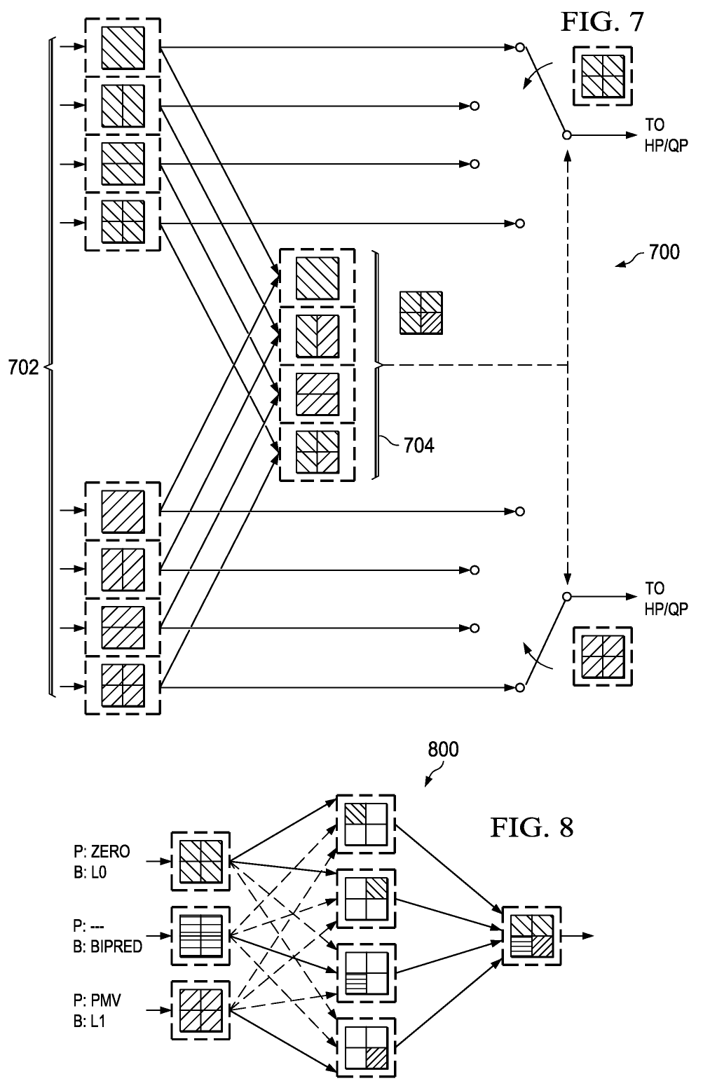

FIG. 7 is an exemplary embodiment of a diagram 700 depicting selecting the best partition size for P-picture macroblock or H.264 B-picture macroblock. In the first partition/step 702, candidates of the selection are formed by choosing the better motion vector. For example, if the candidates are one for each partition size, choosing the better motion vector out of two candidates for each partition would result in four candidates. In the second partition/step 704, the partition size that has the minimum cost among the candidates is selected. The cost consideration includes factors, such as, luminance SAD, motion vector penalty, 8×8 partition penalty as described above, and the like. The intermediate candidates that are generated may not be used in the succeeding stages. In such circumstance, the results of full-pel search of the selected partition size may be used. B-picture macroblocks that do not allow mixed-directional motion compensation may select the partition size that provides the minimum cost out of eight candidates, without generating intermediate candidates.

Sub-pel refinement search refines a motion vector of each partition of the selected partition size to quarter-pel precision. The search itself is similar to full-pel skip box search (SBS), except such a search may be performed on fractional pixel locations and for all of partitions separately at different positions. Half-pel samples are interpolated by using the 6-tap filter that H.264 standard defines.

When the macroblock belongs to a B-picture and bidirectional (interpolated) motion compensation mode is allowed, a bidirectional candidate of the selected partition size is generated by using two motion vectors that are sub-pel refined. The sum of the motion vector penalty for motion vector of each direction may become the penalty of the bidirectional mode. At such point, two (in case of P-picture macroblocks) or three (in case of B-picture macroblocks) candidates may result, which have been sub-pel refined. Such candidates may be unified or selected to produce a single result.

In one embodiment, H.264 B-picture macroblocks may use mixed-directional motion compensation. Such B-pictures may be processed in the same fashion as the P-picture macroblocks.

FIG. 8 is an exemplary embodiment of a diagram 800 depicting unifying search results for P-picture macroblock or H.264 B-picture Macroblock. The motion vector(s) (and motion compensation mode) that provides the minimum cost is selected for each partition, i.e. each 8×8 partition. In FIG. 8, macroblock partition #0 and #1 use L0, #2 use Bipred and #3 uses L1 prediction. B-picture macroblocks, which do not allow mixed-directional motion compensation, select the best prediction mode that provides the minimum cost out of the three modes without mixing the candidates.

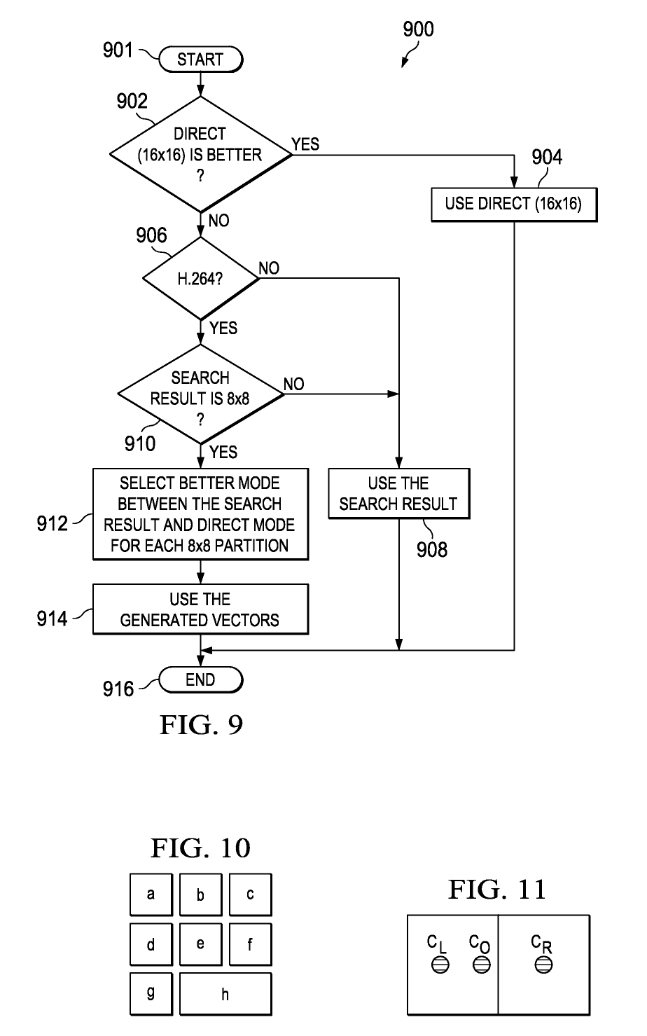

FIG. 9 is a flow diagram depicting an exemplary embodiment of method 900 for direct motion compensation. At step 902 the method 900 determines if the macroblock is a B-picture macroblock. If the macroblock is a B-picture macroblock, contest between the possible direct mode and the search result is conducted. Direct mode is usually free from sending motion vectors. Thus, the penalty of motion vectors is not added to the cost of direct mode.

The method 900 starts at step 901 and proceeds to step 902. At step 902, direct mode and the search result are compared for a whole macroblock. If the direct mode has smaller cost, the method 900 proceeds 900 to step 904, wherein the method 900 uses direct mode for the macroblock. Otherwise, the method 900 proceeds to step 906, wherein the method 900 determines whether the codec is H.264. If the codec is not H.264, the method 900 proceeds to step 908. If the codec is H.264, the method proceeds to step 910. At step 910, the method 900 determined whether the search result is 8×8. If the search result is not 8×8, the method 900 proceeds to step 908. Otherwise the method proceeds to step 912.

At step 908, the method 900 uses the search result. At step 912, the method 900 selects the better mode between the search result and direct mode for each 8×8 partition. At step 914, the method 900 uses the generated vectors. From steps 904, 908 and 914 the method proceeds to step 916. The method 900 ends at step 916.

Therefore, the three step search (NTSS) add search points that surround a center position of search in addition to the normal search patterns. As a result, such an algorithm improves the performance for sequences of the type in question without changing the density of the search.

The solution presented in this invention may cover both two types of source sequences, thus, keeping the same computational complexity: dense search for reliable area and sparse search for unreliable area. Hence, the result is a better search performance. In addition, such a solution does not use irregular search patterns unlike NTSS, which suits to hardware implementation.

While the foregoing is directed to embodiments of the present invention, other and further embodiments of the invention may be devised without departing from the basic scope thereof, and the scope thereof is determined by the claims that follow.

What is claimed is:

1. A motion estimation (ME) method for approximating motion in a macroblock of an image, comprising:
selecting at least one search center in the macroblock;
searching for an adaptive density lattice, wherein the adaptive density lattice search results in a motion vector for the at least one selected search center;
performing skip box search to refine the resulting motion vector;
selecting a partition size for the macroblock utilizing the refined motion vector, resulting in a motion vector candidate; and
performing a sub-pel refinement for the motion vector candidates.

2. The ME method of claim 1, wherein the step of selecting the at least one search center utilizes at least one of a zero motion vector or at least one neighboring motion vector.

3. The ME method of claim 1, wherein the macroblock of the image is at least one of a P-picture microblock or a B-picture microblock.

4. The ME method of claim 1, wherein the step of searching for the adaptive density lattice searches of the best vector amongst more than one partition.

5. The ME method of claim 1, wherein the step of refining the resulting motion vector is performed on more than one partition.

6. The ME method of claim 1, wherein at least one step is performed multiple times.

7. The ME method of claim 1 further comprising at least one of:
evaluating bidirectional prediction utilizing the refined motion vector candidates;
unifying the refined motion vector candidates to result in a unified motion compensation; or
comparing the unified motion compensation and direct mode.

8. Motion Estimation (ME) apparatus for approximating motion in a macroblock of an image, comprising:
means for selecting at least one search center in the macroblock;
means for searching for an adaptive density lattice, wherein the adaptive density lattice search results in a motion vector for the at least one selected search center;
means for performing skip box search to refine the resulting motion vector;
means for selecting a partition size for the macroblock utilizing the refined motion vector, resulting in a motion vector candidate; and
means for performing a sub-pel refinement for the motion vector candidates.

9. The ME apparatus of claim 8, wherein the means for selecting the at least one search center utilizes at least one of a zero motion vector or at least one neighboring motion vector.

10. The ME apparatus of claim 8, wherein the macroblock of the image is at least one of a P-picture microblock or a B-picture microblock.

11. The ME apparatus of claim 8, wherein the means for searching for the adaptive density lattice searches of the best vector amongst more than one partition.

12. The ME apparatus of claim 8, wherein the means for refining the resulting motion vector is performed on more than one partition.

13. The ME apparatus of claim 8, wherein the ME apparatus includes more than one means for selecting at least one search center in the macroblock, means for searching for an adaptive density lattice, means for performing skip box search, means for selecting a partition size for the macroblock or means for performing a sub-pel refinement for the motion vector candidates.

14. The ME apparatus of claim 1 further comprising at least one of:
means for evaluating bi-directional prediction utilizing the refined motion vector candidates;
means for unifying the refined motion vector candidates to result in a unified motion compensation; or
means for comparing the unified motion compensation and direct mode.

15. A computer readable medium comprising software that, when executed by a processor, causes the processor to perform a method comprising:
selecting at least one search center in the macroblock;
searching for an adaptive density lattice, wherein the adaptive density lattice search results in a motion vector for the at least one selected search center;
performing skip box search to refine the resulting motion vector; and
selecting a partition size for the macroblock utilizing the refined motion vector, resulting in a motion vector candidate; and
performing a sub-pel refinement for the motion vector candidates.

16. The computer readable medium of claim 15, wherein the step of selecting the at least one search center utilizes at least one of a zero motion vector or at least one neighboring motion vector.

17. The computer readable medium of claim 15, wherein the macroblock of the image is at least one of a P-picture microblock or a B-picture microblock.

18. The computer readable medium of claim 15, wherein the step of searching for the adaptive density lattice searches of the best vector amongst more than one partition.

19. The computer readable medium of claim 15, wherein the step of refining the resulting motion vector is performed on more than one partition.

20. The computer readable medium of claim 15, wherein at least one step is performed multiple times.

21. The computer readable medium of claim 15 further comprising at least one of:
evaluating bidirectional prediction utilizing the refined motion vector candidates;
unifying the refined motion vector candidates to result in a unified motion compensation; or
comparing the unified motion compensation and direct mode.
